(19) United States
(12) Patent Application Publication
(10) Pub. No.: US 2003/0126208 A1
(43) Pub. Date: Jul. 3, 2003

(54) Network on-line message conversation system, method and registration server

(76) Inventor: Ta-Hsiung Hu, Taipei Hsien (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 10/063,889

(22) Filed: May 22, 2002

(30) Foreign Application Priority Data
Dec. 31, 2001 (TW) 90133090

(51) Int. Cl. G06F 15/16

(52) U.S. Cl. 709/204; 709/206; 709/207

(57) ABSTRACT

A network on-line message conversation system, a method and a registration server. The registration server for the network on-line message conversation comprises a plurality of reading process units, a plurality of writing process units, and a plurality of channel registers. The reading process units that are generated correspond to a plurality of the connection registrations of the user side host one to one, and after receiving the download signal of each user side host, read a plurality of the on-line messages. The writing process units that are generated correspond one to one to a plurality of the connection registrations of the user side host, and are used to write the on-line messages. The channel registers are used to store the on-line messages. The registration server is a real time processing server having a broadcast function to each of the user side hosts that have been registered.

### CROSS REFERENCE TO RELATED APPLICATIONS

This application claims the priority benefit of Taiwan application serial no.90133090, filed Dec. 31, 2001.

### BACKGROUND OF INVENTION

1. Field of Invention

The present invention generally relates to a system, a method and a registration server for network on-line message conversation, and more particularly, to a conversation system and method via the registration server.

2. Description of Related Art

The Internet has united all countries into a global village. Since computers in different locations around the globe have already been united together by the Internet, a user can surf computers in different locations as long as the user is connected to the Internet. If two different users connect to the Internet, online voice chatting can be achieved. Especially nowadays, as the use of broadband gradually increases, the telephone is being used less and less for communication, saving a great amount of the telephone expense. However, each computer needs to know the real Internet Protocol address (abbreviated as IP address) of the opposite party, so both parties can be connected and the voice information can be further delivered to the opposite party.

In companies, it is common for many computers to connect to one IP transfer server. The IP address of the IP transfer server is used as a real electronic communication address to the outside. Therefore, most of the addresses of the user side hosts inside the enterprise are virtual IP addresses. When two computers having virtual IP addresses intend to transmit an audio signal, if the address of the opposite party is unknown, voice communication cannot be processed.

Where the user side host has a virtual IP address, voice communication can still be processed, when one party is a user side host having a virtual IP address but the other party is a user side host having a real IP address. Under such a circumstance, the user side host having the virtual IP address, after the IP address transformation, is still able to initialize connection to the user side host having a real IP address. However, the user side host having a real IP address cannot connect to the user side host having the virtual IP address, because the real address of the user side host having the virtual IP address can not be found.

In summary, when processing conventional voice communication, both parties need to know the real address of the opposing party. Otherwise, communication cannot proceed (under the circumstance of virtual address to virtual address), or only a party having a virtual address can initialize a search for a party having a real address. The party having a real IP address only can passively wait for the connection issued from the party having the virtual address but cannot initialize the request to communicate.

### SUMMARY OF INVENTION

The present invention provides a network on-line message conversation system, wherein the system not only allows both sides having a virtual address to communicate with each other, but also allows one side having a real address to be able to initialize the connection request without passively having to wait for the other side having the virtual address to initialize the connection.

The on-line message conversation system comprises a first user side host, a second user side host, and a registration server.

The first user side host issues a first conversation signal and a first download signal after the network registration is done. The second user side host also issues a second conversation signal that indicates the intention to communicate with the first user host and a second download signal after the network registration is done.

The registration server receives the first conversation signal, the first download signal, the second conversation signal and the second download signal. The registration server comprises a first reading process unit, a first writing process unit, a second reading process unit, a second writing process unit, a first channel register, and a second channel register.

The first reading process unit and the first writing process unit, which are generated to correspond to the connection registration of the first user side host, are used to write the first on-line message and to read the second on-line message. The second reading process unit and the second writing process unit, which are generated to correspond to the second user side host, are used to write the second on-line message and to read the first on-line message. Moreover, the first channel register, which is connected to the first writing process unit and the second reading process unit, is used to store the first on-line message. The second channel register, which is connected to the second writing process unit and the first reading process unit, is used to store the second on-line message.

The present invention further provides a registration server for network on-line message conversation. After receiving the connection registrations of a plurality of the user side hosts, the registration server generates the reading process unit and the writing process unit corresponding to each user side host. After receiving the conversation signals initialized by the user side hosts, the registration server provides a plurality of the channel registers to store the on-line messages, so that the user side host can request to initialize the on-line message downloading.

In the description mentioned above, all the transmission modes of the on-line messages are a kind of streaming transmission mode. Moreover, the network on-line message conversation system and the registration server are also a kind of real time server and system that also has a broadcast function.

The present invention further provides a network on-line message conversation method, comprising: providing a registration file that is used to record a status of the connection registration and a conversation partner of a plurality of users; allowing the user to possess the function of reading and writing an on-line message after one of the user connection registrations is successful; when the conversation partner that the user intends to communicate with is connected and registered in the registration file and has intention to communicate with the user, storing the on-line message of both sides; and when the user and the conversation partner intend to obtain the on-line message of the opposite party, initializing the request to read the on-line message.

In the description mentioned above, all information is downloaded to the user side host for processing the broadcast in a manner of first in first out.

In summary, the present invention allows both sides, that have intention to communicate with each other, to process the conversation just after connecting and registering to the registration server provided by the present invention, no matter if the opposing party is a user side host having a real IP address or a user side host having a virtual IP address, because the registration server can search and determine whether the conversation partner is online or not via the registration file as long as it has been initially connected and registered on to the registration server.

### BRIEF DESCRIPTION OF DRAWINGS

The accompanying drawings are included to provide a further understanding of the invention, and are incorporated in and constitute a part of this specification. The drawings illustrate embodiments of the invention, and together with the description, serve to explain the principles of the invention. In the drawings,

FIG. 1 schematically shows a block diagram of the network on-line message conversation system and the registration server therein of the present invention;

FIG. 2 schematically shows a registration file data table contained in the registration server of FIG. 1 according to the present invention;

FIG. 3a through FIG. 3d schematically shows the response status of a channel register generated by the registration server of FIG. 1 according to the present invention under different access conditions; and

FIG. 4 schematically shows a flow chart of the network on-line message conversation method of the present invention.

### DETAILED DESCRIPTION

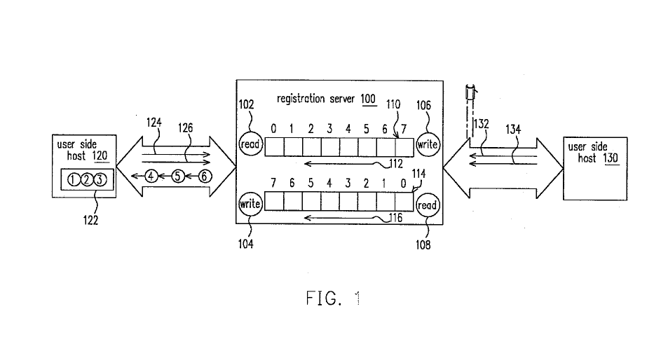

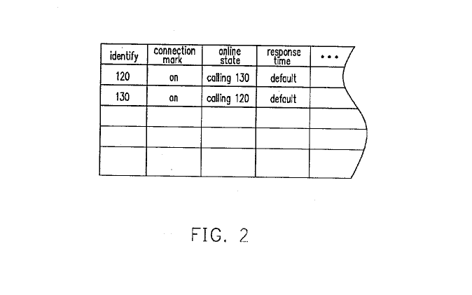

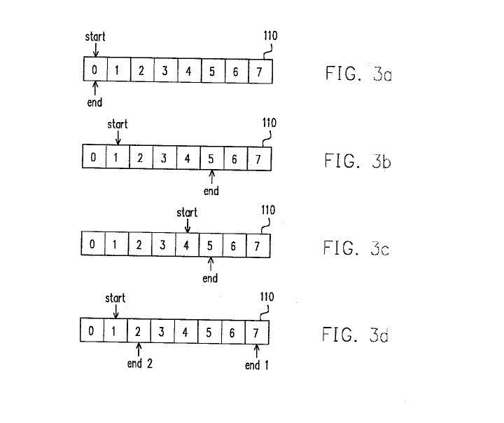

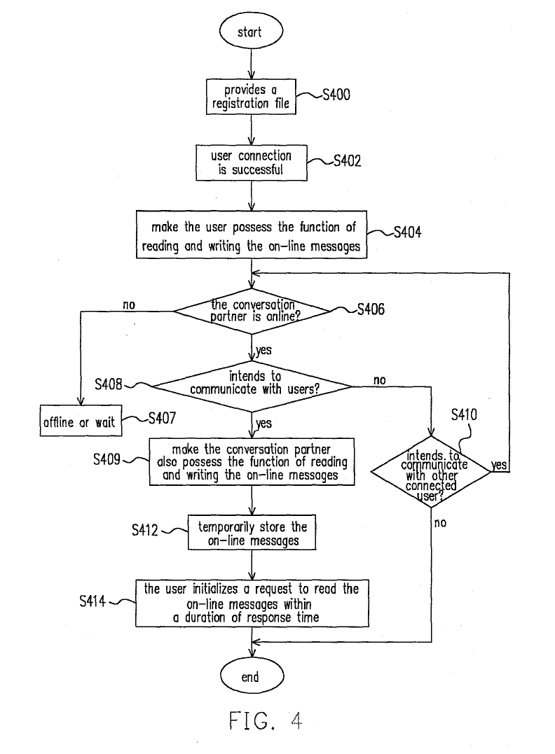

Please refer to FIG. 1, FIG. 2, FIG. 3b and FIG. 4 that schematically show an network on-line message conversation system, a method, a registration server therein, and a registration file and the channel registers contained in the registration server of a preferred embodiment according to the present invention.

The network on-line message conversation system comprises the user side host 120, the user side host 130 and the registration server 100.

When the user side host 120 intends to communicate with somebody, it registers to the registration server 100 on the network, and also issues a conversation signal 124 and a download signal 126. In step s400, when the user side host 120 is registering on to the registration server 100, the registration server 100 provides a registration file for recording the online registration status and the conversation partner of the connected user. The registration file comprises the online personal information such as identity, flag, online state, and response time. Therefore, in step s402, after the user side host 120 has successfully registered the connection registration on the registration server 100, the identity field displays and indicates that the connected user is the user side host 120, the connection mark of the user side host 120 is in the online state, and the response time expected to be used in the conversation is the default value defined by the registration server 100. If the user side host 120 intends to communicate with the user side host having the identity 130, after the conversation signal 124 is uploaded, the online state of the registration file displays and indicates that the user side host having the identity 130 is the one called by the user side host 120.

Furthermore, after the registration server 100 has received the conversation signal 124, the reading process unit 102 and the writing process unit 104 that correspond to the successful connection registration of the user side host 120 are generated, so that the user side host 120 has the function of writing and reading on-line messages (step s404).

Afterwards, in step s406, the registration server 100 searches and determines whether the conversation partner, that is, the user side host having the identity 130 that the user side host 120 intends to communicate with, is online or not according to the registration file of FIG. 2. If the user side host 130 is not online, the user side host 120 can select to disconnect or to stay and wait continuously.

Furthermore, in step s408, after the user side host 130 has registered on the network, the conversation signal 132 issued by the user side host 130 is checked to see whether the user side host 130 intends to communicate with the user side host 120 or not. If it does, the identity field of the registration file of FIG. 2 displays and indicates that the connected user is the user side host 130, the connection flag is in the online state, and the online state also displays that the caller identity 130 has intention to communicate with the user side host having the identity 120.

After the user side host 130 has connected and registered successfully on the registration server 100, the reading process unit 108 and the writing process unit 106 that correspond to the successful connection registration of the user side host 130 are generated, so that the user side host 130 has the function of writing and reading the on-line message (step s409). Moreover, the channel register 110 and 114 are also generated. The channel register 110 connected to the writing process unit 106 and the reading process unit 102, is used to temporarily store the on-line message written by the writing process unit 106 corresponding to the user side host 130. Whereas, the channel register 114 connected to the writing process unit 104 and the reading process unit 108, is used to temporarily store the on-line message written by the writing process unit 104 corresponding to the user side host 120 (step s412).

In step s414, when the user side host 120 intends to obtain the on-line message of the user side host 130, the download signal 126 is initialized to the registration server 100, and after the registration server 100 has received the download signal 126, the reading process unit 102 reads the on-line message that is temporarily stored in the channel register 110 within a duration of the response time defined in the registration file, so that the on-line message is downloaded to the user side host 120. When the user side host 130 intends to obtain the on-line message of the user side host 120, the download signal 134 is initialized to the registration server 100, and after the registration server 100 has received the download signal 134, the reading process unit 108 reads the on-line message that is temporarily stored in the channel register 114 within a duration of the response time defined in the registration file, so that the on-line message is downloaded to the user side host 130.

If the user side host 130 does not intend to communicate with the user side host 120 in step s408, another connected user can also be selected to communicate with (step s410). Then, the user side host 130 can either process the search operation in step s406 and the following steps, or select offline to end the process.

In the description mentioned above, the on-line message may comprise voice information, video information or pure text information.

Furthermore, since the transmission mode of the on-line message designed by the present invention is processed with a streaming mode, that is, the on-line message is transmitted to the user side host at a stable speed, so that the user side host is able to proceed with the on-line message process, such as broadcasting, before all of the transmission is completed. Because of this, the present system or the registration server must be limited to a real time system or server having the capability to respond within the duration of the response time. Otherwise, the on-line message can not be transmitted sequentially in a manner of first in first out to continuously broadcast to the user side host.

Since the present invention is a real time system and server using the streaming transmission mode, the exact transmission of the on-line message becomes much more important. Therefore, reading and writing from/to the same storage address of the same channel register by the reading process unit and the writing process unit of different user side hosts is limited to an exclusive operation. For example, in the channel register 110a as shown in FIG. 3a, when the end pointer of the writing process unit of the user side host 130 and the start pointer of the reading process unit of the user side host 120 are both in the same storage address of the channel register 110 and both of them intend to process the reading and writing from/to the storage address 0, the error on-line message is issued to prevent them from processing the reading and writing from/to the storage address 0 simultaneously. Because the data in the storage address 0 may not have been written yet, or the written data is the data of the previous record, the data read by the reading process unit may not be correct data.

Please refer to FIG. 3b through FIG. 3d. It is assumed that the present invention limits the accessed storage addresses in between the end pointer and the start pointer to be at least one address apart. Otherwise, the data access may not be correct. Therefore, as to the channel register 110 as shown in FIG. 3b, when the end pointer of the writing process unit 106 is in the storage address 5 and the start pointer of the reading process unit 102 is still reading the on-line message of the storage address 1, the reading and writing is under a normal status.

However, if the status is like the one shown in FIG. 3c, that is, when the end pointer of the writing process unit 106 is still in the storage address 5 and the start pointer of the reading process unit 102 has read the on-line message of the storage address 4, since this may indicate that the network of the user side host 130 has some problem, such as the speed is too slow or the enforcement to off line, the registration server 100 issues a warning signal to both conversation parties, one side to warn the reader that the on-line message read may not be correct, and the other side to warn the writer to pay attention to the writing speed.

Furthermore, if the channel register provided by the present invention is a circular register, in the case as shown in FIG. 3d, when the start pointer of the reading process unit 102 is still on the on-line message of the storage address 1 and the end pointer 1 of the next message of the writing process unit 106 is written into the last storage address of the channel register 110 (herein the storage address is assumed to be the storage address 7), because this is a circular register, assuming the writing process 106 writes from end pointer 1 to end pointer 2 (assumed to be storage address 2), the storage address after the storage address 1 that is the start pointer of the reading process unit 102, the point where the reading process unit 102 begins to read the last message of writing process unit 106 overlaps with the end of the next message. In such a case may indicate the network of the user side host 120 has some problem, such as the speed is too slow or enforcement to off line. Therefore, the registration server 100 issues a warning signal to both conversation parties, one side to warn the reader to pay attention to the reading speed because the on-line message that is going to be read may not be correct, and the other side to warn the writer to suspend the transmission of the on-line message.

The descriptions mentioned above all use two user side hosts as examples. However, the registration server 100 provided by the present invention also can be a broadcast transmission server. When one user intends to process the on-line message transmission with a specific or non-specific registered user on the network, the broadcast function can be used to process the on-line message transmission.

In summary, the advantages of the present invention allow both sides, that have intention to communicate with each other, to process a conversation just after connecting and registering to the registration server provided by the present invention, no matter if the opposing party is a user side host having a real IP address or a user side host having a virtual IP address, because the registration server can search and determine whether the conversation partner is online or not via the registration file, as long as it has been initially connected and registered on to the registration server.

Moreover, the on-line message is transmitted by using a real-time streaming mode, thus not only can the on-line message be read within a short duration of the response time, but also the on-line message can be broadcast even if the whole online message has not been delivered to the receiving side yet, and the correctness of the transmission of the on-line message is still kept.

Although the invention has been described with reference to a particular embodiment thereof, it will be apparent to one of the ordinary skill in the art that modifications to the described embodiment may be made without departing from the spirit of the invention. Accordingly, the scope of the invention will be defined by the attached claims not by the above detailed description.

1. An network on-line message conversation system, comprising:
a first user side host, wherein the first user side host processes the registration on the network, and issues a first conversation signal and a first download signal;
a second user side host, wherein the second user side host processes the registration on the network, and issues a second conversation signal that indicates the intention to communicate with the first user side host and a second download signal; and
a registration server for receiving the first conversation signal, the first download signal, the second conversation signal and the second download signal, wherein the registration server comprises:
a first reading process unit and a first writing process unit that are generated corresponding to the first user side host connection registration, and are used to write a first on-line message and to read a second on-line message;
a second reading process unit and a second writing process unit that are generated corresponding to the second user side host connection registration, and are used to write the second on-line message and to read the first on-line message;
a first channel register connected to the first writing process unit and the second reading process unit that is used to store the first on-line message; and
a second channel register connected to the second writing process unit and the first reading process unit that is used to store the second on-line message.

2. The network on-line message conversation system of claim 1, wherein the registration server comprises a registration file that includes the identity, the flag and the state of the first user side host and the second user side host.

3. The network on-line message conversation system of claim 1, wherein the first on-line message and the second on-line message comprise voice information, video information and pure text information.

4. The network on-line message conversation system of claim 1, wherein the first writing process unit and the second reading process unit can not process the writing and reading operation of the first on-line message on the same storage address of the first channel register at the same time.

5. The network on-line message conversation system of claim 1, wherein the second writing process unit and the first reading process unit can not process the writing and reading operation of the second on-line message on the same storage address of the second channel register at the same time.

6. The network on-line message conversation system of claim 1, wherein the first user side host and the second user side host can be a user side host having either a virtual IP address or a real IP address.

7. The network on-line message conversation system of claim 1, wherein the first channel register and the second channel register can be a circular register.

8. The network on-line message conversation system of claim 1, wherein the transmission method of the first on-line message and the second on-line message is a streaming communication mode.

9. The network on-line message conversation system of claim 1, wherein the network on-line message conversation system is a real time system.

10. A registration server for network on-line message conversation, comprising:
a plurality of reading process units, wherein each reading process unit is generated corresponding to each of a plurality of user side host connection registrations, and after receiving a plurality of download signals issued by the user side hosts, reads a plurality of on-line messages;
a plurality of writing process units, wherein each writing process unit that is generated corresponding to each of a plurality of user side host connection registrations is used to write the on-line messages; and
a plurality of channel registers, used to store the on-line messages.

11. The registration server for network on-line message conversation of claim 10, wherein each of the reading process units and each of the writing process units of each of the user side hosts corresponds to a channel register respectively.

12. The registration server for network on-line message conversation of claim 11, wherein reading and writing from/to the same storage address of the same channel register is exclusive.

13. The registration server for network on-line message conversation of claim 10, wherein the transmission method of the on-line message is a streaming communication mode.

14. The registration server for network on-line message conversation of claim 10, wherein the registration server is a real time processing server.

15. The registration server for network on-line message conversation of claim 10, wherein the registration server is a broadcast transmission server.

16. The registration server for network on-line message conversation of claim 10, wherein the registration server comprises a registration file that includes the identity, the flag and the state of the user side hosts.

17. The registration server for network on-line message conversation of claim 10, wherein the user side hosts can be a user side host having either a virtual IP address or a real IP address.

18. A network on-line message conversation method, comprising:
providing a registration file that is used to record a status of the connection registration and a conversation partner of a plurality of users;
allowing the user to posses the function of reading and writing an on-line message after a user connection registration is successful;
determining whether the conversation partner that the user intends to communicate with, is also online or not, and determining whether the conversation partner intends to communicate with the user or not via the registration file;
wherein when the conversation partner that the user intends to communicate with, is connected and registered in the registration file and also has intention to communicate with the user, temporarily storing the on-line message written by the user and the conversation partner; and
wherein when the user and the conversation partner intend to obtain the on-line message of the opposing party, reading the stored on-line message initialized within a duration of the response time.

19. The network on-line message conversation method of claim 18, wherein the on-line message comprises voice information, video information and pure text information.

20. The network on-line message conversation method of claim 18, wherein the on-line message received by the user is broadcast sequentially in a manner of first come first serve.
